(19) United States
(12) Patent Application Publication
(10) Pub. No.: US 2019/0313339 A1
(43) Pub. Date: Oct. 10, 2019

(54) WIFI POWER SUPPLY SWITCHING METHOD, CIRCUIT AND APPARATUS, AND STORAGE MEDIUM

(71) Applicant: ZTE CORPORATION, Shenzhen, Guangdong (CN)

(72) Inventor: Qiang LEI, Shenzhen, Guangdong (CN)

(21) Appl. No.: 16/315,848

(22) PCT Filed: Feb. 8, 2017
(86) PCT No.: PCT/CN2017/073089

§ 371 Date: Jan. 7, 2019

(30) Foreign Application Priority Data
Jul. 6, 2016 (CN) 201610527914.2

(51) Int. Cl. H04W 52/02

(52) U.S. Cl. CPC H04W 52/0251

(57) ABSTRACT

Provided are a WIFI power supply switching method, circuit and apparatus, and a storage medium. The method includes: when it is detected that a terminal is disconnected from an external power supply circuit, detecting a main current from a battery to a main board of the terminal and determining whether the main current goes beyond a first pre-set threshold value, wherein the battery supplies power for a WIFI PA of a first frequency band and a WIFI PA of a second frequency band in the terminal; and when it is determined that the main current goes beyond the first pre-set threshold value, ending the power supply of the battery for the WIFI PA of the first frequency band.

### TECHNICAL FIELD

The present disclosure relates to the field of communications, and in particular, to a wireless fidelity (WIFI) power supply switching method, circuit and apparatus, and storage medium.

### BACKGROUND

With the rapidly widespread use of WIFI, there are more and more situations for people to use WIFI, for example, transmitting pictures, watching movies online, thus the amount of data has increased dramatically, and the requirements for real-time are increasing. WIFI channels in a single 2.4 GHz band is particularly crowded and the interference increases. The corresponding circuit of the onsite Power Amplifier (PA) is used for amplifying transmitting signals, and the 5.8 GHz WIFI is generated in this background, which is to solve the problem of congestion in the 2.4 GHz band. However, due to the need to supply power to the PA of both frequency bands at the same time, power consumption is inevitably increased, which puts a test on the design of the WIFI device. Especially when an adapter is switched to be supplied by the battery, the instantaneous surge current of the battery is too large, which causes a battery voltage decreasing, thus the device to be shut down. To avoid this situation, it is necessary to increase the power supply capacity of the battery, which can be achieved by increasing cost and volume. But an increase in power supply capacity means, as for a general lithium battery, an increase in volume and thickness, and as for lithium ion polymer batteries, means an increase in cost. Through the design improvement, the application realizes the smooth power supply switching from the adapter to the battery under a WIFI dual-band power supply without increasing the cost and volume of the battery.

In the related art, a smooth transition of power supply switching from adapter to battery power can be achieved by increasing the capacity of the battery and the instantaneous current supply capability. However, an increase in power supply capability, as for a general lithium battery, means an increase in volume and thickness, and as for lithium ion polymer batteries, means an increase in cost.

In view of the above problems in the related art, no effective solution has been found yet.

### SUMMARY

The present disclosure provides a WIFI power supply switching method, circuit and apparatus, and storage medium to solve the problem that smooth power supply switching from external circuit to battery is only possible by increasing battery capacity in the related art.

According to an embodiment of the present disclosure, a WIFI power supply switching method is provided, including: detecting, when it is detected that a terminal is disconnected from an external power supply circuit, a main current from a battery to a main board of the terminal and determining whether the main current goes beyond a first pre-set threshold value, wherein the battery supplies power for a WIFI PA of a first frequency band and a WIFI PA of a second frequency band in the terminal; and ending, when it is determined that the main current goes beyond the first pre-set threshold value, the power supply of the battery for the WIFI PA of the first frequency band.

In an implementation, after ending the power supply of the battery for the WIFI PA of the first frequency band, the method further includes: detecting the main current; and starting, when the main current is less than or equal to a second pre-set threshold value, the power supply of the battery for the WIFI PA of the first frequency band.

In an implementation, after ending the power supply of the battery for the WIFI PA of the first frequency band, the method further includes: reducing a power of the WIFI PA of the second frequency band.

In an implementation, the WIFI PA of the first frequency band is a WIFI PA of 5.8 GHz band, and the WIFI PA of the second frequency band is a WIFI PA of 2.4 GHz band.

According to another embodiment of the present disclosure, a WIFI power supply switching circuit is provided, which is applied to a terminal using dual-band WIFI, including a first detecting circuit, a control circuit and a power supply switch circuit, wherein the first detecting circuit is configured to detect, when the terminal is disconnected from an external power supply circuit, a main current from a battery to a main board of the terminal and determine whether the main current goes beyond a first pre-set threshold value, and send, when the main current goes beyond the first pre-set threshold value, a first signal to the control circuit, wherein the battery supplies power for a WIFI PA of a first frequency band and a WIFI PA of a second frequency band in the terminal; the control circuit is connected to the first detecting circuit, and configured to send a first control signal to the power supply switch circuit through the first signal to control a disconnection of the power supply switch circuit; and the power supply switch circuit is connected to the control circuit and configured to end a power supply of the battery for the WIFI PA of the first frequency band according to the first control signal.

In an implementation, the power supply switch circuit reduces, after the power supply of the battery for the WIFI PA of the first frequency band is ended, a power of the WIFI PA of the second frequency band through a trigger signal.

In an implementation, the control circuit is further configured to receive, when it is detected by the first detecting circuit that the main current is less than or equal to a second pre-set threshold value, a second signal sent by the first detecting circuit, and send, according to the second signal, a second control signal for starting the power supply of the battery for the WIFI PA of the first frequency band to the power supply switch circuit, wherein the second pre-set threshold value is less than the first pre-set threshold value.

In an implementation, the first detecting circuit includes: a current sampling amplifier configured to collect the main current; and a comparator connected between the current sampling amplifier and the control circuit, and configured to compare the main current with a pre-set threshold value, and send a first signal, when the main current goes beyond the first pre-set threshold value, and a second signal, when the main current is less than or equal to a second pre-set threshold value, to the control circuit.

In an implementation, the power supply switching circuit further includes: a second detecting circuit connected to the first detecting circuit, and configured to detect whether the terminal is disconnected from the external power supply circuit, and trigger, when it is detected that the terminal is disconnected from the external power supply circuit, the first detection circuit to operate.

In another embodiment, a WIFI power supply switching apparatus is provided, including: a detecting module configured to detect, when it is detected that a terminal is disconnected from an external power supply circuit, a main current from a battery to a main board of the terminal and determine whether the main current goes beyond a first pre-set threshold value, wherein the battery supplies power for a WIFI PA of a first frequency band and a WIFI PA of a second frequency band in the terminal; and a processing module configured to end, when it is determined that the main current goes beyond the first pre-set threshold value, the power supply of the battery for the WIFI PA of the first frequency band.

According to another embodiment of the present disclosure, a storage medium is provided to store computer executable instructions for performing the following steps: detecting, when it is detected that a terminal is disconnected from an external power supply circuit, a main current from a battery to a main board of the terminal and determining whether the main current goes beyond a first pre-set threshold value, wherein the battery supplies power for a WIFI PA of a first frequency band and a WIFI PA of a second frequency band in the terminal; and ending, when it is determined that the main current goes beyond the first pre-set threshold value, the power supply of the battery for the WIFI PA of the first frequency band.

According to the technical solution of the embodiment of the present disclosure, when it is detected that a terminal is disconnected from an external power supply circuit, a main current from a battery to a main board of the terminal is detected and it is determined whether the main current goes beyond a first pre-set threshold value, wherein the battery supplies power for a WIFI PA of a first frequency band and a WIFI PA of a second frequency band in the terminal; and when it is determined that the main current goes beyond the first pre-set threshold value, the power supply of the battery for the WIFI PA of the first frequency band is ended. Since that when the main current of the terminal is too high, the power supply of the battery for the WIFI PA of the first frequency band is ended, and the power supply of the battery for the WIFI PA of the second frequency band is maintained, it is possible to solve the problem that smooth power supply switching from external circuit to battery is only possible by increasing battery capacity in the related art. Therefore, the smooth power supply switching from the external circuit to the battery under the WIFI dual-band power supply is realized without increasing the cost and volume of the battery.

### BRIEF DESCRIPTION OF THE FIGURES

The drawings described herein which constitute a part of the present disclosure are provided for further understanding the present disclosure. The exemplary embodiments of the present disclosure and the descriptions thereof are intended to explain the present disclosure and should not be considered as a limitation of the present disclosure. In the drawings:

FIG. 1 is a structural block diagram of a hardware of a mobile terminal for performing a WIFI power supply switching method according to an embodiment of the present disclosure;

FIG. 2 is a flowchart of a WIFI power supply switching method according to an embodiment of the present disclosure;

FIG. 3 is a structural block diagram of a WIFI power supply switching circuit according to an embodiment of the present disclosure;

FIG. 4 is a schematic structural diagram of a first detecting circuit according to an embodiment of the present disclosure;

FIG. 5 is a structural block diagram of a WIFI power supply switching apparatus according to an embodiment of the present disclosure:

FIG. 6 is a structural block diagram of a power supply switching apparatus according to an embodiment of the present disclosure;

FIG. 7 is a circuit diagram according to an embodiment of the present disclosure: and

FIG. 8 is a schematic diagram of a workflow according to an embodiment of the present disclosure.

### DETAILED DESCRIPTION

The present invention will be described in detail below in conjunction with embodiments by reference to the drawings. It should be appreciated that the embodiments and the features in the embodiments of the present application may be combined as long as they do not conflict with each other.

It should be noted that the terms “first”, “second” and the like in the specification and claims of the present disclosure and the above-mentioned drawings are used to distinguish similar objects, and should not be used to describe a specific sequence or an order.

### First Embodiment

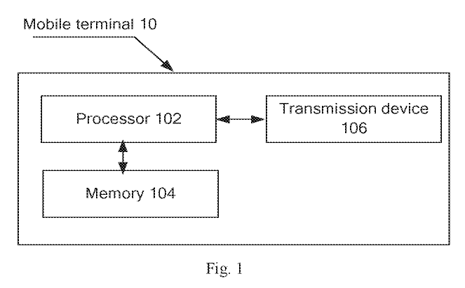

The method provided in the first embodiment of the present application can be performed in a mobile terminal, a computer terminal or the like computing device. Taking the mobile terminal as an example. FIG. 1 is structural block diagram of a hardware of a mobile terminal for performing a WIFI power supply switching method according to an embodiment of the present disclosure. As shown in FIG. 1, the mobile terminal 10 may include one or more (only one shown) processors 102 (the processor 102 may include, but is not limited to, a processing device such as a Micro Controller Unit (MCU) or a programmable logic device (FPGA, Field Programmable Gate Array)), a memory 104 for storing data, and a transmission device 106 for a communication function. It will be understood by those skilled in the art that the structure shown in FIG. 1 is merely illustrative, and does not limit the structure of the above electronic device. For example, the mobile terminal 10 may also include more or fewer components than those shown in FIG. 1, or have a different configuration than that shown in FIG.

The memory 104 may be used to store software programs and modules of application software, such as program instructions/modules corresponding to the WIFI power supply switching method according to an embodiment of the present disclosure. The processor 102 executes various functional applications and data processing by running a software program and a module stored in the memory 104, that is, the above method is implemented. Memory 104 may include high-speed random access memory, and may also include non-volatile memory such as one or more magnetic storage devices, flash memory, or other non-volatile solid-state memory. In some examples, the memory 104 may further include memory provided remotely relative to the processor 102, which may be connected to mobile terminal 10 via a network. Examples of such networks include, but are not limited to, the Internet, Intranet, Local Area Network, mobile communication network, and combinations thereof.

Transmission device 106 is used for receiving or transmitting data via a network. Specifically, the above network may include a wireless network provided by a communication service provider of the mobile terminal 10. For example, the transmission device 106 includes a Network Interface Controller (NIC) that can be connected to other network devices through a base station to communicate with the Internet. For example, the transmission device 106 can be a radio frequency (RF) module for communicating with the Internet wirelessly.

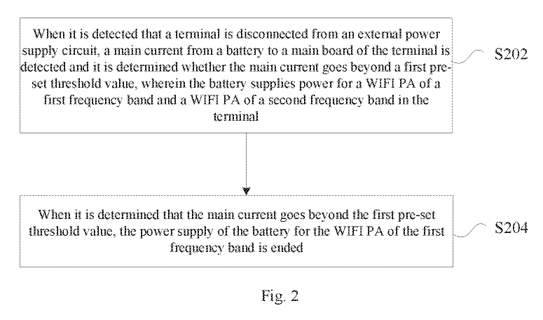

A WIFI power supply switching method running on the mobile terminal is provided in this embodiment. FIG. 2 is a flowchart of the WIFI power supply switching method according to an embodiment of the present disclosure. As shown in FIG. 2, the process includes the steps 202 and 204.

At step 202, when it is detected that a terminal is disconnected from an external power supply circuit, a main current from a battery to a main board of the terminal is detected and it is determined whether the main current goes beyond a first pre-set threshold value, wherein the battery supplies power for a WIFI PA of a first frequency band and a WIFI PA of a second frequency band in the terminal;

At step 204, when it is determined that the main current goes beyond the first pre-set threshold value, the power supply of the battery for the WIFI PA of the first frequency band is ended.

Through the above steps, when it is detected that the terminal is disconnected from the external power supply circuit, the main current from the battery to the main board of the terminal is detected and it is determined whether the main current goes beyond a first pre-set threshold value, wherein the battery supplies power for the WIFI PA of the first frequency band and the WIFI PA of the second frequency band in the terminal; and when it is determined that the main current goes beyond the first pre-set threshold value, the power supply of the battery for the WIFI PA of the first frequency band is ended. When the main current of the terminal is too high, the power supply of the battery for the WIFI PA of the first frequency band is ended, and the power supply of the battery for the WIFI PA of the second frequency band is maintained. Thus, it is possible to solve the problem that smooth power supply switching from external circuit to battery is only possible by increasing battery capacity in the related art. Therefore, the smooth power supply switching from the external circuit to the battery under the WIFI dual-band power supply is realized without increasing the cost and volume of the battery.

In an implementation, the execution body of the above steps may be a terminal, such as a controller, a battery management circuit, etc., but is not limited thereto.

In this embodiment, the WIFI PA of the first frequency band may be a WIFI PA of 5.8 GHz band, and the WIFI PA of the second frequency band may be a WIFI PA of 2.4 GHz band, the two frequency bands that are used by the dual-band WIFI terminal in the related art. Of course, a WIFI network with other frequency bands can also be used.

In an implementation, when it is determined that the main current goes beyond the first pre-set threshold value, the power supply of the battery for the WIFI PA of the first frequency band is ended, and then the power of the WIFI PA of the second frequency band is also reduced to turn on the 5.8 GHz WIFI PA. Reduce the power of the 2.4 GHz WIFI PA, and then start the power supply for the 5.8 GHz WIFI PA to maintain the current balance.

In an optional implementation of the embodiment, after ending the power supply of the battery for the WIFI PA of the first frequency band, it is also possible to select whether to supply power to the WIFI PA of the first frequency band according to the real-time current, specifically including steps 11 and 12.

At step 11, the main current is detected in a pre-set cycle.

At step 12, when the main current is less than or equal to a second pre-set threshold value, the power supply of the battery for the WIFI PA of the first frequency band is started. In an implementation, the second pre-set threshold value may be less than or equal to the first pre-set threshold value. When the second pre-set threshold value is less than the first pre-set threshold value, the overall system is more stable due to the consideration of the current pull-up caused by the recovery of the power supply for the WIFI PA of the first frequency band.

Through the description of the above implementations, those skilled in the art can clearly understand that the method according to the above embodiment can be implemented by a combination of software and a necessary general hardware platform, and of course, it can also be implemented by hardware. However, the former is a better implementation in many cases. Based on such understanding, the essence of the technical solution of the present disclosure or the part of which contributing to the related art can be embodied in the form of a software product. The computer software product is stored in a storage medium (such as a ROM/RAM, a magnetic disk, an optical disk), and includes a plurality of instructions for causing a terminal device (which may be a mobile phone, a computer, a server, or a network device, etc.) to perform methods of various embodiments of the present disclosure.

### Second Embodiment

In this embodiment, a WIFI power supply switching circuit and apparatus are also provided, which are applied to implement the above embodiments and implementations, and the same descriptions have been omitted. As used below, the term “module” may implement a combination of software and/or hardware of a predetermined function. Although the apparatus described in the following embodiments are preferably implemented by software, hardware or a combination of software and hardware, is also possible and may be contemplated.

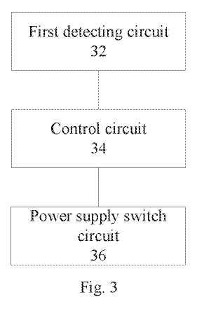

FIG. 3 is a structural block diagram of a WIFI power supply switching circuit according to an embodiment of the present disclosure. As shown in FIG. 3, the circuit includes a first detecting circuit 32, a control circuit 34 and a power supply switch circuit 36.

The first detecting circuit 32 is configured to detect, when the terminal is disconnected from an external power supply circuit, a main current from a battery to a main board of the terminal and determine whether the main current goes beyond a first pre-set threshold value; and send, when the main current goes beyond the first pre-set threshold value, a first signal to the control circuit 34, wherein the battery supplies power for a WIFI PA of a first frequency band and a WIFI PA of a second frequency band.

The control circuit 34 is connected to the first detecting circuit 32 and configured to send a first control signal to the power supply switch circuit 36 through the first signal to control a disconnection of the power supply switch circuit.

The power supply switch circuit 36 is connected to the control circuit 34 and configured to end a power supply of the battery for the WIFI PA of the first frequency band according to the first control signal.

In an implementation, the circuit further includes: a second detecting circuit connected to the first detecting circuit, and configured to detect whether the terminal is disconnected from the external power supply circuit, and trigger, when it is detected that the terminal is disconnected from the external power supply circuit, the first detection circuit to operate.

In an implementation, the power supply switch circuit 36 calls, after the power supply of the battery for the WIFI PA of the first frequency band is ended, a power adjustment program through a trigger signal, and reduces power of the WIFI PA of the second frequency band. Specifically, it can be controlled by software, such as lowering the power supply level, reducing the current, reducing the voltage, and the like.

In an implementation, the first detecting circuit is further configured to continuously detect, after the power supply of the battery for the WIFI PA of the first frequency band is ended by the power supply switch circuit 36, the main current in a pre-set cycle. The control circuit 34 is further configured to receive, when it is detected by the first detecting circuit 32 that the main current is less than or equal to a second pre-set threshold value, a second signal sent by the first detecting circuit 32, and send, according to the second signal, a second control signal for starting the power supply of the battery for the WIFI PA of the first frequency band to the power supply switch circuit 36, wherein the second pre-set threshold value is less than the first pre-set threshold value.

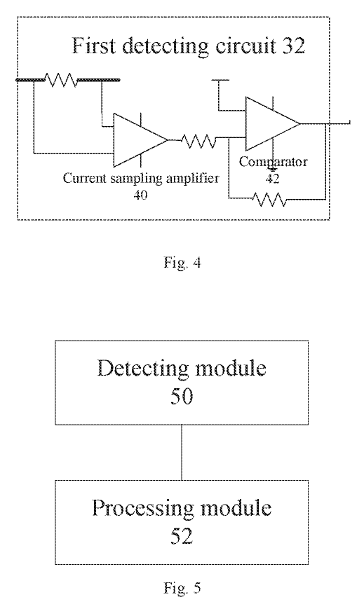

FIG. 4 is a schematic structural diagram of the first detecting circuit according to an embodiment of the present disclosure. As shown in FIG. 4, the first detecting circuit 32 further includes: a current sampling amplifier 40 configured to collect main current; and a comparator 42 connected between the current sampling amplifier 40 and the control circuit 34, and configured to compare the main current with a pre-set threshold value, and send a first signal, when the main current goes beyond the first pre-set threshold value, and a second signal, when the main current is less than or equal to a second pre-set threshold value, to the control circuit 34.

The comparator 42 can be implemented by a voltage comparator, an input terminal of the voltage comparator may receive a voltage signal. By the current sampling amplifier, the collected main current is converted into a voltage value and the converted voltage value is input to the voltage comparator. By the voltage comparator, the converted voltage value is compared with a reference voltage value (corresponding to the pre-set threshold value) and a digital signal (such as a first signal and a second signal) is output according to the comparison result.

FIG. 5 is a structural block diagram of a WIFI power supply switching apparatus according to an embodiment of the present disclosure. As shown in FIG. 5, the apparatus includes a detecting module 50 and a processing module 52.

The detecting module 50 is configured to detect, when it is detected that a terminal is disconnected from an external power supply circuit, a main current from a battery to a main board of the terminal and determine whether the main current goes beyond a first pre-set threshold value, wherein the battery supplies power for a WIFI PA of a first frequency band and a WIFI PA of a second frequency band in the terminal.

The processing module 52 is configured to end, when it is determined that the main current goes beyond the first pre-set threshold value, the power supply of the battery for the WIFI PA of the first frequency band.

It should be noted that the above modules may be implemented by software or hardware. The latter can be implemented in the following manner, but is not limited thereto: the above modules are all located in the same processor; or the above modules are respectively located in different processors in any combination.

### Third Embodiment

This embodiment is an optional embodiment according to the present disclosure for specifically describing the solution.

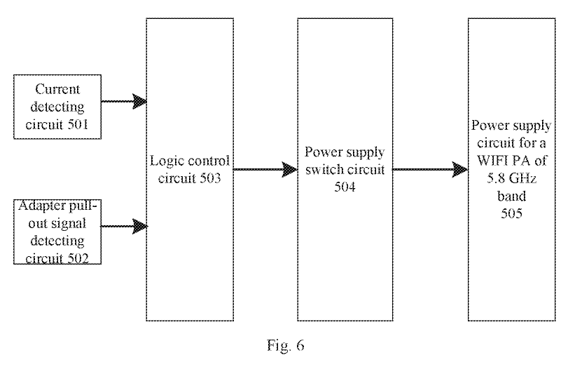

This embodiment provides a power supply switching scheme for power supply switching from power adapter to battery under the WIFI dual-band power supply. Since the 5.8 GHz is rarely used, it is selected that the power supply for the WIFI PA of the 5.8 GHz band is controlled to buffer the instantaneous current. Although the PA has a power outage time, the time under such control is very short, and users generally cannot feel that. FIG. 6 is a structural block diagram of a power supply switching apparatus according to an embodiment of the present disclosure. As shown in FIG. 6, apparatus shown in this embodiment includes five parts: a current detecting circuit 501, an adapter pull-out signal detecting circuit 502, a logic control circuit 503, a power supply switch circuit 504, and a power supply circuit 505 for a WIFI PA of a certain frequency band. The current detecting circuit 501 (i.e., the first part) detects current on a main circuit. If the current goes beyond the allowable value after the adapter is pulled out, a signal is output to the logic control circuit, and the power supply for the 5.8 G Hz PA is ended to reduce the current and protect the battery supply voltage. If the current does not go beyond the allowable value, there is no need to end the power supply for the PA. If the current does not go beyond the allowable value, there is no need to end the power supply for the 5.8 GHz PA. The adapter pull-out signal detecting circuit 502 (i.e., the second part) provides the logic control circuit 503 with a pull-out signal at the moment when the adapter is pulled out, which requires high real-time performance. The logic control circuit 503 (i.e., the third part) performs logic processing on signals of the first part and the second part to provide a control signal to the subsequent circuit. The power supply switch circuit 504 (i.e., the fourth part) receives the control signal from the third part 503, and controls the power supply circuit 505 for the WIFI PA of the certain frequency band to be turned on/off. The power supply circuit 505 for the WIFI PA of the certain frequency band (i.e., the fifth part) supplies power for the WIFI PA of the certain frequency band.

In the embodiment, the pull-out signal is provided to the logic control circuit at the moment when the adapter is pulled out, and according to the output of the current detecting circuit, the logic control circuit determines whether to control the power supply switch circuit to end power supply for the 5.8 GHz band WIFI PA, and when the power supply for the 5.8 GHz band WIFI PA is ended, a configuration of the other frequency band may be reduced by software, such as the 1*1 mode, and then the current change is monitored by the current detecting circuit; when the current is reduced to the allowable value, the power supply for the 5.8 GHz band WIFI PA is started by the logic control circuit. The whole process is basically completed by hardware and has a fast speed, and users generally cannot feel that, which achieves a smooth transition of the power supply switching process. This will be explained in detail below.

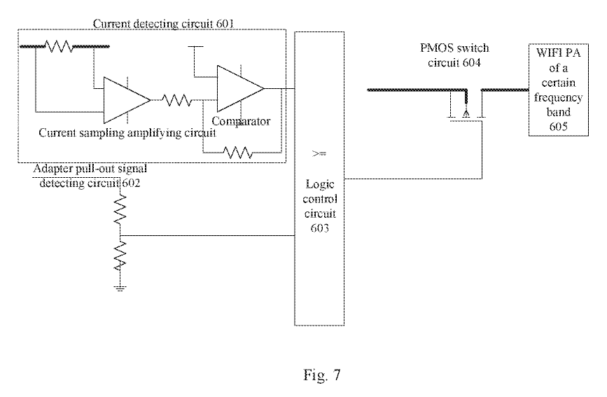

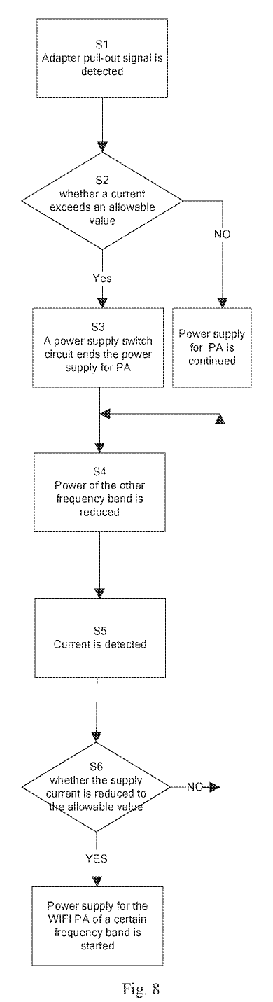

FIG. 7 is a circuit diagram according to an embodiment of the present disclosure. As shown in FIG. 7, a specific circuit 602, corresponding to the adapter pull-out signal detecting circuit 502 in FIG. 6, may collect a power supply signal of the adapter through a voltage dividing resistor, and a surge protection tube protection circuit is added to prevent generating surge voltage. A high-level signal is generated here when the adapter is plugged in, and a low-level signal is generated when the adapter is pulled out. The signal is output to the logic control circuit 503 in FIG. 6.

The current detecting circuit 601 includes three parts: a current sampling resistor, a current sampling amplifying circuit and a comparator. When the adapter is pulled out, a current sampling value is greater than a threshold voltage VREF due to the presence of a surge current, the comparator output a low-level signal to the logic control circuit 603. By combining with the adapter pull-out signal detecting circuit 602, the logic circuit 603 and the power supply switch circuit 604, after taking a series of measures to reduce the current, when the current drops to a threshold value, the comparator outputs a high-level signal, and the logic control circuit 603 turns on the switch circuit 604 to restore the power supply for the 5.8 GHz PA.

A specific circuit 603, corresponding to the logic circuit 503 in FIG. 6, is a logic gate circuit 603 with an “NOR” logic. When the adapter is plugged, a high-level signal is input, and a high-level signal is also output by the current detecting circuit 601, then a low-level signal is output by the logic NOR gate. In this case, the power supply circuit 605 for a WIFI PA of a certain frequency band is in an on-state. When the adapter is pulled out, the adapter pull-out signal is in a low-level, if the current does not go beyond the allowable value, the current detecting circuit 601 still outputs a high-level signal and output of the logic NOR gate won't change, still in a low-level; if the current goes beyond the allowable value, output of the current detecting circuit 601 becomes a low-level signal, and the logic NOR gate outputs a high-level signal and the switch of the power supply switch circuit 604 is in an off-state. The power supply circuit 505 in FIG. 6 is in an off-state. At this time, the power of another frequency band of WIFI is appropriately reduced. State of current is monitored by the current detecting circuit 501 in FIG. 6, when the current reaches the allowable value, output of the logic control “NOR” gate is a low-level signal, the power supply switch circuit 504 in FIG. 6 is in the on-state.

A specific circuit 604, corresponding to the power supply switch circuit 504 in FIG. 6, is a PMOS switch circuit 604. When the logic “NOR” gate outputs a low-level signal, the power supply circuit for a WIFI PA of a certain frequency band is turned on. When the logic “NOR” gate outputs a high-level signal, the power supply circuit 505 for a WIFI PA of a certain frequency band in is FIG. 6 turned off.

FIG. 8 is a schematic diagram of a workflow according to an embodiment of the present disclosure. As shown in FIG. 8, the method includes steps S1 to S6.

At step S1, detecting, by an adapter pull-out signal detecting circuit, that an adapter has been pulled out, an output of the adapter pull-out signal detecting circuit turns to a high-level signal from a low-level signal.

At step S2, determining whether a current exceeds an allowable value; if exceeds, a logic control circuit outputs a high-level signal, and a power supply switch circuit ends a power supply for a PA; if not exceed, the PA of 5.8 GHz band remains being powered.

At step S3, a control terminal of a power supply switch changes from a low level to a high level, the switch is turned off, and the power supply for a PA of a certain frequency band is ended.

At step S4, when the power supply for the WIFI PA is ended, the power of the other frequency band is reduced to decrease the total supply current.

At step S5, a current detecting circuit detects the current value of the whole power supply circuit.

At step S6, determining whether the supply current is reduced to the allowable value; if it has been reduced to the allowable value, a logic gate outputs a low-level signal, and the power supply switch is turned on, and the power supply for the WIFI PA of a certain frequency band is restored; if it has not been reduced to the allowable value, the power of the other frequency band is further reduced, and then continue the detection and determination until it is reduced to the allowable value.

Through the embodiment, the smooth power supply switching from the adapter to a battery under a WIFI dual-band power supply is realized without increasing the cost and volume of the battery.

### Fourth Embodiment

An embodiment of the present disclosure also provides a storage medium. In this embodiment, the above storage medium may be arranged to store program code for performing the steps 41 to 42.

At step 41, when it is detected that a terminal is disconnected from an external power supply circuit, a main current from a battery to a main board of the terminal is detected and it is determined whether the main current goes beyond a first pre-set threshold value, wherein the battery supplies power for a WIFI PA of a first frequency band and a WIFI PA of a second frequency band in the terminal;

At step 42, when it is determined that the main current goes beyond the first pre-set threshold value, the power supply of the battery for the WIFI PA of the first frequency band is ended.

In an implementation of the embodiment, the above storage medium may include, but not limited to, a variety of media that can store program code, such as a USB flash drive, a Read-Only Memory (ROM), a Random Access Memory (RAM), a mobile hard disk, and a magnetic disk or an optical disk.

In an implementation of the embodiment, according to the stored program code in the storage medium, a processor performs steps of detecting, when it is detected that a terminal is disconnected from an external power supply circuit, a main current from a battery to a main board of the terminal and determining whether the main current goes beyond a first pre-set threshold value, wherein the battery supplies power for a WIFI PA of a first frequency band and a WIFI PA of a second frequency band in the terminal.

In an implementation of the embodiment, according to the stored program code in the storage medium, the processor performs step of ending, when it is determined that the main current goes beyond the first pre-set threshold value, the power supply of the battery for the WIFI PA of the first frequency band.

In an implementation, the specific examples in this embodiment may refer to the examples described in the above embodiments and the optional implementations, and details are not described herein again.

It will be apparent to those skilled in the art that the various modules or steps of the present disclosure described above can be implemented by a general computing device, which can be integrated in a single computing device or distributed across a network of multiple computing devices. Optionally, they may be implemented by program code executable by the computing device such that they may be stored in the storage device to be executed by the computing device. In some cases, the steps shown or described herein may be performed in a different order, or they may be separately fabricated into individual integrated circuit modules, or a plurality of modules or steps thereof may be implemented as a single integrated circuit module. Thus, the present disclosure is not limited to any specific combination of hardware and software.

The above descriptions are only embodiments of the present disclosure, and is not intended to limit the disclosure, and various changes and modifications may be made to the present disclosure. Any modifications, equivalents, improvements, etc. made within the spirit and scope of the present disclosure are intended to be included within the scope of the present disclosure.

### INDUSTRIAL APPLICABILITY

According to the technical solution of the embodiment of the present disclosure, when it is detected that a terminal is disconnected from an external power supply circuit, a main current from a battery to a main board of the terminal is detected and it is determined whether the main current goes beyond a first pre-set threshold value, wherein the battery supplies power for a WIFI PA of a first frequency band and a WIFI PA of a second frequency band in the terminal; when it is determined that the main current goes beyond the first pre-set threshold value, the power supply of the battery for the WIFI PA of the first frequency band is ended. When the main current of the terminal is too high, the power supply of the battery for the WIFI PA of the first frequency band is ended, and the power supply of the battery for the WIFI PA of the second frequency band is maintained. Thus, it is possible to solve the problem that smooth power supply switching from external circuit to battery is only possible by increasing battery capacity in the related art. Therefore, the smooth power supply switching from the external circuit to the battery under the WIFI dual-band power supply is realized without increasing the cost and volume of the battery.

1. A wireless fidelity (WIFI) power supply switching method, comprising:
detecting, when it is detected that a terminal is disconnected from an external power supply circuit, a main current from a battery to a main board of the terminal, wherein the battery supplies power for a WIFI Power Amplifier (PA) of a first frequency band and a WIFI PA of a second frequency band in the terminal; and
ending, when it is determined that the main current goes beyond a first pre-set threshold value, the power supply of the battery for the WIFI PA of the first frequency band.

2. The WIFI power supply switching method according to claim 1, wherein after ending the power supply of the battery for the WIFI PA of the first frequency band, the method further comprises:
detecting the main current; and
starting, when the main current is less than or equal to a second pre-set threshold value, the power supply of the battery for the WIFI PA of the first frequency band.

3. The WIFI power supply switching method according to claim 1, wherein after ending the power supply of the battery for the WIFI PA of the first frequency band, the method further comprises:
reducing a power of the WIFI PA of the second frequency band.

4. The WIFI power supply switching method according to claim 1, wherein the WIFI PA of the first frequency band is a WIFI PA of 5.8 GHz band, and the WIFI PA of the second frequency band is a WIFI PA of 2.4 GHz band.

5. A WIFI power supply switching circuit, which is applied to a terminal using dual-band WIFI, comprising a first detecting circuit, a control circuit and a power supply switch circuit, wherein
the first detecting circuit is configured to detect, when the terminal is disconnected from an external power supply circuit, a main current from a battery to a main board of the terminal and send, when the main current goes beyond a first pre-set threshold value, a first signal to the control circuit, wherein the battery supplies power for a WIFI PA of a first frequency band and a WIFI PA of a second frequency band in the terminal;
the control circuit is connected to the first detecting circuit, and configured to send a first control signal to the power supply switch circuit through the first signal to control a disconnection of the power supply switch circuit; and
the power supply switch circuit is connected to the control circuit and configured to end a power supply of the battery for the WIFI PA of the first frequency band according to the first control signal.

6. The WIFI power supply switching circuit according to claim 5, wherein the power supply switch circuit reduces, after the power supply of the battery for the WIFI PA of the first frequency band is ended, a power of the WIFI PA of the second frequency band through a trigger signal.

7. The WIFI power supply switching circuit according to claim 5, wherein the control circuit is further configured to receive, when it is detected by the first detecting circuit that the main current is less than or equal to a second pre-set threshold value, a second signal sent by the first detecting circuit, and send, according to the second signal, a second control signal for starting the power supply of the battery for the WIFI PA of the first frequency band to the power supply switch circuit, wherein the second pre-set threshold value is less than the first pre-set threshold value.

8. The WIFI power supply switching circuit according to claim 5, wherein the first detecting circuit comprises:
a current sampling amplifier configured to collect the main current; and
a comparator connected between the current sampling amplifier and the control circuit, and configured to compare the main current with a pre-set threshold value, and send a first signal, when the main current goes beyond the first pre-set threshold value, and/or a second signal, when the main current is less than or equal to a second pre-set threshold value, to the control circuit.

9. The WIFI power supply switching circuit according to claim 5, wherein the power supply switching circuit further comprises:
a second detecting circuit connected to the first detecting circuit, and configured to detect whether the terminal is disconnected from the external power supply circuit, and trigger, when it is detected that the terminal is disconnected from the external power supply circuit, the first detection circuit to operate.

10. A WIFI power supply switching apparatus, comprising:
a detecting module configured to detect, when it is detected that a terminal is disconnected from an external power supply circuit, a main current from a battery to a main board of the terminal, wherein the battery supplies power for a WIFI PA of a first frequency band and a WIFI PA of a second frequency band in the terminal; and
a processing module configured to end, when it is determined that the main current goes beyond a first pre-set threshold value, the power supply of the battery for the WIFI PA of the first frequency band.

11. A storage medium storing computer executable instructions, wherein the computer executable instructions are configured to perform the WIFI power supply switching method according to claim 1.
